(19) United States
(12) Patent Application Publication
(10) Pub. No.: US 2026/0253320 A1
(43) Pub. Date: Aug. 27, 2026

(54) METHOD AND APPARATUS FOR IMAGE INVERSE RENDERING, AND DEVICE AND MEDIUM

(71) Applicant: REALSEE (BEIJING) TECHNOLOGY CO., LTD., Beijing (CN)

(72) Inventors: Zhen LI, Beijing (CN); Lingli WANG, Beijing (CN); Xiang HUANG, Beijing (CN); Cihui PAN, Beijing (CN)

(73) Assignee: REALSEE (BEIJING) TECHNOLOGY CO., LTD., Beijing (CN)

(21) Appl. No.: 18/875,821

(22) PCT Filed: Feb. 7, 2023
(86) PCT No.: PCT/CN2023/074800

§ 371 Date: Dec. 17, 2024

(30) Foreign Application Priority Data
Jun. 17, 2022 (CN) 202210689653.X

(51) Int. Cl. G06T 15/50; G06T 7/60

(52) U.S. Cl. CPC G06T 15/50; G06T 7/60; G06T 2207/20081; G06T 2207/20084

(57) ABSTRACT

The present disclosure relates to a method, device, equipment and medium for inverse rendering an image. The method includes: inputting an image to be processed into a feature prediction model, predicting a geometric feature and a material feature of the image to be processed by the feature prediction mode to acquire a geometric feature map and a material feature map of the image to be processed, where the geometric feature map includes a normal map and a depth map, and the material feature map includes an albedo feature map, a roughness feature map, and a metalness feature map; inputting the image to be processed, the geometric feature map and the material feature map into a lighting prediction model, and predicting a lighting value of the image to be processed pixel by pixel by the lighting prediction model to acquire a lighting feature map of the image to be processed.

The present disclosure claims a priority from Chinese patent application No. 202210689653.X entitled “METHOD, DEVICE, EQUIPMENT AND MEDIUM FOR INVERSE RENDERING IMAGES”, which is filed with CNIPA on Jun. 17, 2022, and the entire contents of which are incorporated into the present disclosure by reference.

### FIELD

The present disclosure relates to the field of computer vision, and in particular to a method, device, equipment and medium for inverse rendering an image.

### BACKGROUND

Image inverse rendering is an important application in the field of computer graphics and computer vision. Its purpose is to recover geometry, material, lighting and other attributes of an image from the image. In the field of mixed reality and scene digitization, images may be processed based on the geometry, material, lighting and other properties acquired by inverse rendering. For example, virtual objects may be generated in the image. The geometry, material, lighting and other properties of the image acquired by inverse rendering are directly related to the fusion effect of virtual objects and scenes.

### SUMMARY

According to embodiments of the present disclosure, a method, device, equipment and medium for inverse rendering images is provided, which are used to improve the effect of image processing based on material representation acquired by inverse rendering.

According to an aspect of the present disclosure, a method for inverse rendering an image is provided, the method includes:

inputting an image to be processed into a feature prediction model, predicting a geometric feature and a material feature of the image to be processed by the feature prediction model to acquire a geometric feature map and a material feature map of the image to be processed, where the geometric feature map includes a normal map and a depth map, and the material feature map includes an albedo feature map, a roughness feature map, and a metalness feature map;
inputting the image to be processed, the geometric feature map and the material feature map into a lighting prediction model, and predicting a lighting value of the image to be processed pixel by pixel by the lighting prediction model to acquire a lighting feature map of the image to be processed; and
performing preset processing on the image to be processed based on the geometric feature map, the material feature map and the lighting feature map.

According to another aspect of the present disclosure, a device for inverse rendering an image is provided, the device includes: a feature predicting unit configured to input an image to be processed into a feature prediction model, predict a geometric feature and a material feature of the image to be processed by the feature prediction model to acquire a geometric feature map and a material feature map of the image to be processed, where the geometric feature map includes a normal map and a depth map, and the material feature map includes an albedo feature map, a roughness feature map, and a metalness feature map;
a lighting predicting unit configured to input the image to be processed, the geometric feature map and the material feature map into a lighting prediction model, and predict a lighting value of the image to be processed pixel by pixel by the lighting prediction model to acquire a lighting feature map of the image to be processed; and
an image processing unit configured to perform preset processing on the image to be processed based on the geometric feature map, the material feature map and the lighting feature map.

According to another aspect of the present disclosure, an electronic device is provided, which includes a memory configured to store a computer program product; and
a processor configured to execute the computer program product stored in the memory, and implement the method for inverse rendering images of any one of the above-mentioned embodiments of the present disclosure when the computer program product is executed.

According to another aspect of the present disclosure, a computer-readable storage medium is provided, on which program code is stored. The program code may be called and executed by a processor to implement the method for inverse rendering images provided in any one of the above embodiments of the present disclosure.

In the solution according to the embodiments of the present disclosure, a feature prediction model may be used to predict the geometric feature and material feature of the image to be processed, where the geometric feature include a normal feature and a depth feature, and the material feature include base color, roughness, and metalness; then, a lighting prediction model is used to predict the lighting value of the image to be processed, and the preset processing is performed on the image based on the predicted geometric feature, material feature, and lighting value. Through the depth feature, base color, roughness and metalness, complex materials in the image to be processed can be represented more physically and accurately. As a result, complex lighting environments such as specular reflections can be modeled in more detail during subsequent processing, which can overcome the limitations of simplified material representation on appearance obtaining in the inverse rendering process, help improve the physical correctness of materials, geometry and lighting predicted by inverse rendering, and improve the effect of image processing that relies on material representation acquired by inverse rendering. For example, in the fields of mixed reality and scene digitization, this can be used to improve the integration effect of virtual objects and scenes.

The technical solution of the present disclosure is further described in detail hereinafter through the accompanying drawings and embodiments.

### BRIEF DESCRIPTION OF THE DRAWINGS

The accompanying drawings, which constitute a part of the description, illustrate embodiments of the present disclosure and, together with the description, serve to explain the principles of the present disclosure.

The present disclosure can be more clearly understood from the following detailed description with reference to the accompanying drawings. Obviously, the drawings described hereinafter are only some embodiments of the present disclosure. For those skilled in the art, other drawings can be obtained based on these drawings without creative work:

FIG. 1 is a flowchart of a method for inverse rendering an image according to an embodiment.

FIG. 2 is a schematic diagram of a scene of the method for inverse rendering the image according to the present disclosure.

FIG. 3 is a schematic diagram of a process of training a feature prediction model and a lighting prediction model of a method for inverse rendering an image according to one embodiment.

FIG. 4 is a schematic diagram of a process of pre-training a lighting prediction model a method for inverse rendering an image according to one embodiment.

FIG. 5 is a schematic diagram of a flowchart of calculating a spatial loss function a method for inverse rendering an image according to one embodiment.

FIG. 6 is a schematic diagram of a structure of a device for inverse rendering an image according to an embodiment.

FIG. 7 is a schematic diagram of a structure of an electronic device according to an application embodiment.

### DESCRIPTION OF THE PREFERRED EMBODIMENTS

Various exemplary embodiments of the present disclosure will now be described in detail with reference to the accompanying drawings. It should be noted that the relative arrangement of components and steps, the numerical expressions and numerical values as mentioned above in these embodiments do not limit the scope of the present disclosure unless otherwise specified.

It should also be understood that in the embodiments of the present disclosure, “plurality” may refer to two or more than two, and “at least one” may refer to one, two, or more than two.

Those skilled in the art may understand that the terms “first” and “second” in the embodiments of the present disclosure are only used to distinguish different steps, devices or modules, etc., and neither represent any specific technical meaning nor indicate the necessary logical order between them.

It should also be understood that any component, data or structure mentioned in the embodiments of the present disclosure may generally be understood as one or more, unless explicitly limited or otherwise indicated in the context.

It should also be understood that the description of the various embodiments in the present disclosure focuses on the differences between the various embodiments, and the same or similar aspects thereof may be referenced to each other, and for the sake of brevity, they will not be described one by one.

The following description of at least one exemplary embodiment is merely illustrative in nature and is in no way intended to limit the present disclosure, its application, or uses.

Technologies, methods, and equipment known to those skilled in the art may not be discussed in detail, but where appropriate, such technologies, methods, and equipment should be considered part of the description.

It should be noted that like reference numerals and letters refer to similar items in the following figures, and therefore, once an item is defined in one figure, it need not be further discussed in subsequent figures.

In addition, the term “and/or” in the disclosure is merely a description of the association relationship of associated objects, indicating that three relationships may exist. For example, A and/or B may represent three situations: A exists alone, A and B exist at the same time, and B exists alone. In addition, the character “/” in the present disclosure generally indicates that the preceding and following associated objects are in an “or” relationship.

The embodiments of the present disclosure may be applied to electronic devices such as terminal devices, computer systems, and servers, and may operate with many other general or special computing system environments or configurations. Examples of well-known terminal devices, computing systems, environments and/or configurations suitable for use with terminal devices, computer systems, servers and other electronic devices include, but are not limited to: personal computer systems, server computer systems, thin clients, thick clients, handheld or laptop devices, microprocessor-based systems, set-top boxes, programmable consumer electronics, network personal computers, minicomputer systems, mainframe computer systems and distributed cloud computing technology environments including any of the above systems, etc.

Electronic devices such as terminal devices, computer systems, and servers may be described in the general context of computer system executable instructions (such as program modules) executed by the computer system. Generally, program modules may include routines, programs, objects, components, logic, data structures, etc. that perform particular tasks or implement particular abstract data types. The computer system/server may be implemented in distributed cloud computing environments where tasks are performed by remote processing devices that are linked through a communications network. In a distributed cloud computing environment, program modules may be located on local or remote computing system storage media including memory storage devices.

In order to make the technical solutions and advantages in the embodiments of the present disclosure more clearly understood, exemplary embodiments of the present disclosure are further described below in conjunction with the accompanying drawings. Obviously, the described embodiments are only part of the embodiments of the present disclosure, rather than an exhaustive list of all the embodiments. It should be noted that, in the absence of conflict, the embodiments and features in the embodiments of the present disclosure may be combined with each other.

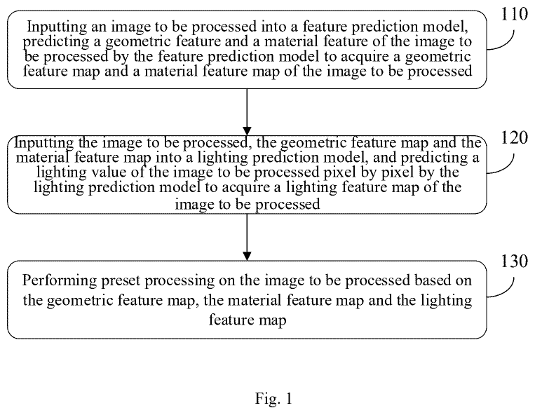

The method for inverse rendering images disclosed in the present disclosure is exemplarily described hereinafter with reference to FIG. 1. FIG. 1 shows a flowchart of a method for inverse rendering an image according to an embodiment of the present disclosure. As shown in FIG. 1, the flowchart includes the following steps.

Step 110: inputting an image to be processed into a feature prediction model, predicting a geometric feature and a material feature of the image to be processed by the feature prediction model to acquire a geometric feature map and a material feature map of the image to be processed.

The geometric feature map includes a normal map and a depth map, and the material feature map includes an albedo feature map, a roughness feature map, and a metalness feature map.

In this embodiment, the geometric feature may characterize a geometric property of the image to be processed, for example, may include a normal feature and a depth feature. The normal feature may characterize a normal vector of a pixel point, and the depth feature may characterize a depth of a pixel point. The material feature may represent a material property of a pixel of the image to be processed, for example, may include base color, roughness and metalness. The base color may represent the ratio of a light flow scattered in at least one direction by the entire illuminated part of the object surface to the light flow incident on the object surface. Roughness may indicate the smoothness of an object's surface and is used to describe the behavior of light when it hits the surface of an object. For example, the smaller the roughness of a surface of an object, the closer the light is to mirror reflection when it hits the surface of the object. Metalness is used to characterize the metallic degree of an object. The higher the metalness, the closer the object is to metal, and vice versa, the closer it is to non-metal.

The feature prediction model may characterize the correspondence between the image to be processed and its geometric features and material features, and is used to predict the geometric feature and the material feature of each pixel in the image to be processed, and form a corresponding feature map based on the predicted feature values. Correspondingly, the normal map, depth map, albedo feature map, roughness feature map and metalness feature map may respectively represent the normal vector, depth, base color, roughness and metalness of at least one pixel point in the image to be processed.

In a specific example, the feature prediction model may be any neural network model such as a convolutional neural network, a residual network, etc., such as a multi-branch encoder-decoder based on ResNet and Unet, the encoder may be ResNet-18 and the decoder may be composed of 5 convolutional layers with skip connections. After training the feature prediction model with sample data, the feature prediction model may be used to realize feature extraction, down-sampling, extraction of high-dimensional features, up-sampling, decoding, leap-layer connection, fusion of shallow features and other processing of the image to be processed, and finally predict the normal feature, depth feature, base color, roughness and metalness of each pixel in the image to be processed, and form the normal feature map, depth feature map, albedo feature map, roughness feature map and metalness feature map based on the predicted feature value, so as to acquire the geometric feature and material feature of the image to be processed.

In an optional example, step 110 may be executed by a processor calling corresponding instructions stored in a memory, or may be executed by a feature prediction unit executed by the processor.

Step 120: inputting the image to be processed, the geometric feature map and the material feature map into a lighting prediction model, and predicting a lighting value of the image to be processed pixel by pixel by the lighting prediction model to acquire a lighting feature map of the image to be processed.

In this embodiment, the lighting value may represent the lighting environment of a point in space. The lighting prediction model may characterize the correspondence between the image to be processed and its geometric feature, material feature and lighting environment.

In a specific example, the lighting prediction model may adopt any neural network model such as a convolutional neural network, a residual network, etc., such as a multi-branch encoder-decoder based on ResNet and Unet. An execution subject (for example, a terminal device or a server) superimposes the image to be processed, the geometric feature map (including the normal feature map and the depth feature map), and the material feature map (including the albedo feature map, the roughness feature map, and the metalness feature map) on the number of channels through preprocessing, and then inputs the superimposed image into the lighting prediction model, predicts the spatial lighting environment of each pixel, that is, the lighting value of each pixel after feature extraction, encoding, decoding and other operations, and forms a spatially continuous HDR lighting feature map based on the predicted lighting values.

In an optional example, step 120 may be executed by a processor calling corresponding instructions stored in a memory, or may be executed by a lighting prediction unit executed by the processor.

Step 130: performing preset processing on the image to be processed based on the geometric feature map, the material feature map and the lighting feature map.

In this embodiment, through step 110 and step 120, inverse rendering of the image to be processed may be achieved to obtain the geometric feature and material feature of the image to be processed. Preset processing refers to the subsequent processing of the image to be processed based on the geometric feature and material feature acquired by inverse rendering. For example, in the field of mixed reality, the real image captured by the camera may be used as the image to be processed, and the virtual image may be inserted into the real image, thereby realizing the fusion of the physical world and the virtual image. For another example, a virtual object may be generated in the image to be processed through dynamic virtual object synthesis based on the geometric feature and material feature of the image to be processed. For another example, the material of the object in the image to be processed may be edited based on the geometric feature and material feature of the image to be processed to present objects of different materials.

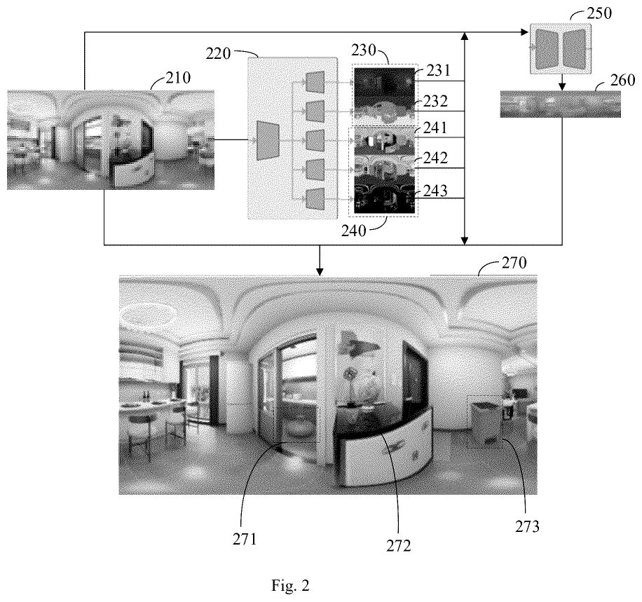

The method for inverse rendering images in this embodiment is exemplarily described below with reference to the scene shown in FIG. 2. As shown in FIG. 2, the image to be processed 210 is an LDR panoramic image. The feature prediction model 220 may be used to predict the geometric feature map 230 and the material feature map 240 of the image to be processed210. The geometric feature map includes a normal feature map 231 and a depth feature map 232, and the material feature map includes an albedo feature map 241, a roughness feature map 242 and a metalness feature map 243. Afterwards, the image to be processed 210, the geometric feature map 230, and the material feature map 240 are input into a second prediction model 250 to acquire the lighting feature map 260. Thereafter, based on the geometric feature map 230 and the material feature map 240, a virtual object 271, a virtual object 272, and a virtual object 273 are generated in the image to be processed 210 to acqurie a processed image 270.

In an optional example, step 130 may be executed by a processor calling corresponding instructions stored in a memory, or may be executed by an image processing unit executed by the processor.

The method for inverse rendering images according to this embodiment may use a feature prediction model to predict the geometric feature and material feature of the image to be processed, where the geometric feature include a normal feature and a depth feature, and the material feature include base color, roughness, and metalness; then, a lighting prediction model is used to predict the lighting value of the image to be processed, and the preset processing is performed on the image based on the predicted geometric feature, material feature, and lighting value. Through the depth feature, base color, roughness and metalness, complex materials in the image to be processed can be represented more physically and accurately. As a result, complex lighting environments such as specular reflections can be modeled in more detail during subsequent processing, which can overcome the limitations of simplified material representation on appearance obtaining in the inverse rendering process, help improve the physical correctness of materials, geometry and lighting predicted by inverse rendering, and improve the effect of image processing that relies on material representation acquired by inverse rendering.

In some optional implementations of this embodiment, the above step 120 may further include: processing the image to be processed, the geometric feature map and the material feature map by using the lighting prediction model, predicting the lighting value of the pixel point in the image to be processed, and generating a panoramic image corresponding to the pixel point based on the predicted lighting value; and splicing the panoramic image corresponding to the pixel point in the image to be processed to acquire a lighting feature map.

In this embodiment, the lighting prediction model may predict the lighting environment of each pixel in space by processing the image to be processed, the geometric feature map and the material feature map. Since a point in space may receive light emitted from any angle, a 360° panoramic image may be used to characterize the lighting environment of the point. Afterwards, based on the position of the pixel point in the image to be processed, the panoramic image corresponding to at least one pixel point is spliced into a lighting feature map.

In this embodiment, the lighting values of pixels in the image to be processed are predicted by a lighting prediction model, and the lighting values of the pixels are characterized by using a panoramic image, so that the lighting characteristics of the image to be processed can be more accurately characterized.

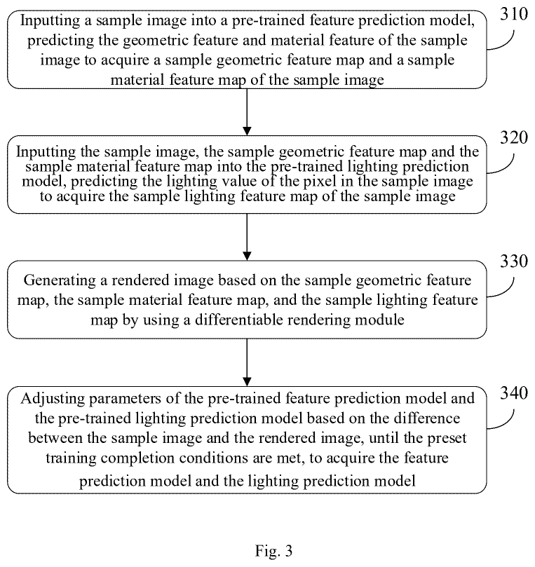

Subsequently, referring to FIG. 3, FIG. 3 shows a schematic diagram of a process of training a feature prediction model and a lighting prediction model of a method for inverse rendering an image according to one embodiment. As shown in FIG. 3, the process includes the following steps.

Step 310: inputting a sample image into a pre-trained feature prediction model, predicting the geometric feature and the material feature of the sample image to acquire a sample geometric feature map and a sample material feature map of the sample image.

In this embodiment, the pre-trained feature prediction model refers to a feature prediction model that has been trained and may complete the prediction operation on the input image.

As an example, a virtual data set may be used to pre-train a feature prediction model. The virtual data set may include a virtual image acquired by forward rendering and a virtual geometric feature map and a virtual material feature map generated during the forward rendering process. Then, the virtual image is used as the input of the initial-feature prediction model, and the virtual geometric feature map and the virtual material feature map are used as the expected outputs. The initial-feature prediction model is trained to acquire a pre-trained feature prediction model.

In an optional example, step 310 may be executed by a processor calling corresponding instructions stored in a memory, or may be executed by a model training unit executed by the processor.

Step 320: inputting the sample image, the sample geometric feature map and the sample material feature map into the pre-trained lighting prediction model, predicting the lighting value of the pixel point in the sample image to acquire the sample lighting feature map of the sample image.

In this embodiment, the pre-trained lighting prediction model refers to a lighting prediction model that has been trained and may complete the prediction operation on the sample image, the sample geometric feature map, and the sample material feature map.

As an example, a virtual data set may be used to implement pre-training of a lighting prediction model. The virtual data set may include a virtual image acquired by forward rendering and a virtual geometric feature map, a virtual material feature map, and a virtual lighting feature map generated during the forward rendering process. The virtual image, the virtual geometric feature map and the virtual material feature map is used as input, and the virtual lighting feature map is used as the expected output. The initial lighting prediction model is trained to acquire a pre-trained feature prediction model.

In an optional example, step 320 may be executed by the processor calling the corresponding instructions stored in the memory, or may be executed by the model training unit run by the processor.

Step 330: generating a rendered image based on the sample geometric feature map, the sample material feature map, and the sample lighting feature map by using a differentiable rendering module.

In the related art, when an image is generated by rendering, in the ray tracing stage, since it is impossible to determine the relationship between the light received by the camera and the entire scene, the rendering process is non-differentiable. The reverse conduction of the neural network is achieved through differentiation, so the non-differentiable rendering process cannot provide constraints for the neural network.

In this embodiment, the sample geometric feature map, sample material feature map and sample lighting feature map acquired by inverse rendering are images acquired by mapping the feature values to the camera space. The differentiable rendering module does not need to perform ray tracing, but directly calculates the shading value by using the sample geometric feature map, sample material feature map and sample lighting feature map, thereby generating a rendered image through differentiable rendering processing.

As an example, the differentiable rendering module may determine the normal vector, base color, roughness and metalness of each pixel from the sample geometric feature map, the sample material feature map and the sample lighting feature map, and then substitute the normal vector, base color, roughness, metalness and lighting value into the rendering equation, and then solve the rendering equation through Monte Carlo sampling method to determine a shading value of the pixel. Herein, in order to generate more detailed specular reflections, the importance sampling method may be used to calculate the Monte Carlo integral.

Following formulas (1) to (6) show the differentiable rendering process in this example, where formula (1) is a rendering equation.

$$\tilde{I} = {f}_{d} {\int }_{{H}^{+}} {L}_{i} ( {ω}_{i} ) ( {ω}_{i} \cdot n ) {d ω}_{i} + {\int }_{{H}^{+}} {f}_{s} {L}_{i} ( {ω}_{i} ) ( {ω}_{i} \cdot n ) {d ω}_{i} \qquad ( 1 )$$

$${f}_{d} = \frac{B ( 1 - M )}{π} \qquad ( 2 )$$

$${f}_{s} = \frac{DFG}{4 ( n \cdot v ) ( n \cdot l )} \qquad ( 3 )$$

$$D = \frac{{α}^{2}}{{π ( {( n \cdot h )}^{2} ( {α}^{2} - 1 ) + 1 )}^{2}} \qquad ( 4 )$$

$$h = bisector ( v , l ) \qquad ( 5 )$$

$$α = {R}^{2} \qquad ( 6 )$$

Where, f_{d} represents the diffuse reflection attribute component, fₛ represents the specular reflection attribute component, Ĩ represents the coloring value, Lᵢ represents the lighting value, ωᵢ represents the incident angle of the light, n represents the normal vector, B represents the base color, M represents the metalness, R represents the roughness, D, F, G, v, l, and h are all intermediate variables in the rendering process, and their calculation methods are common knowledge in the art and will not be repeated here.

In an optional example, step 330 may be executed by the processor calling corresponding instructions stored in the memory, or may be executed by a model training unit executed by the processor.

Step 340: adjusting parameters of the pre-trained feature prediction model and the pre-trained lighting prediction model (i.e., training the pre-trained feature prediction model and the pre-trained lighting prediction model) based on the difference between the sample image and the rendered image, until the preset training completion conditions are met to acquire the feature prediction model and the lighting prediction model.

As an example, the preset training completion condition may be that the loss function converges or the number of iterative executions of steps 310 to 240 reaches a preset number of times.

For example, the execution subject may use an L1 function or an L2 function as a rendering loss function, and then determine a value of the rendering loss function based on a difference between a sample image and a rendered image, and afterwards, uses the reverse conduction characteristics of the neural network to adjust the parameters of the pre-trained feature prediction model and the pre-trained lighting prediction model by deriving the rendering loss function until the function value of the rendering loss function converges to acquire the feature prediction model and the lighting prediction model.

For another example, when the number of iterative executions of steps 310 to 340 reaches a preset number, the training may be terminated to acquire a feature prediction model and a lighting prediction model.

In this embodiment, a rendered image is generated through differentiable rendering processing based on the geometric features, material features, and lighting features obtained by inverse rendering, and based on the differences between the rendered image and the sample image, the parameters of the pre-trained feature prediction model and the pre-trained lighting prediction model are adjusted, which can provide physical constraints for the feature prediction model and the lighting prediction model, thereby improving the accuracy of the feature prediction model and the lighting prediction model, which helps to improve the accuracy of the attributes acquired by inverse rendering.

In an optional example, step 340 may be executed by the processor calling the corresponding instructions stored in the memory, or may be executed by the model training unit run by the processor.

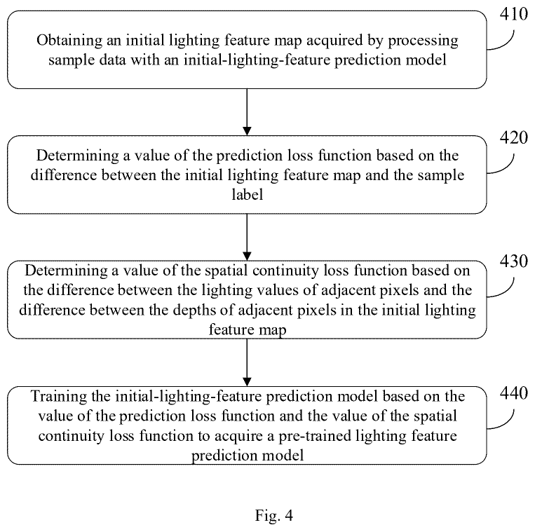

In some optional implementations of the above embodiment, the pre-training process of the lighting feature prediction model may adopt the process shown in FIG. 4. As shown in FIG. 4, the process includes the following steps.

Step 410: obtaining an initial lighting feature map acquired by processing sample data with an initial-lighting-feature prediction model.

As an example, the sample data may include a virtual image acquired by forward rendering and a virtual geometric feature map, a virtual material feature map, and a virtual lighting feature map generated during the forward rendering process. The virtual image, the virtual geometric feature map and the virtual material feature map may be used as input, and the virtual lighting feature map may be used as a sample label.

In an optional example, step 410 may be executed by a processor calling corresponding instructions stored in a memory, or may be executed by a pre-training unit executed by the processor.

Step 420: determining a value of the prediction loss function based on the difference between the initial lighting feature map and the sample label.

In this embodiment, the prediction loss function represents the degree of difference between the output of the initial lighting prediction model and the sample label. For example, an L1 function or an L2 function may be used as the prediction loss function.

In an optional example, step 420 may be executed by the processor calling corresponding instructions stored in the memory, or may be executed by a pre-training unit executed by the processor.

Step 430: determining a value of the spatial continuity loss function based on the difference between the lighting values of adjacent pixels and the difference between the depths of adjacent pixels in the initial lighting feature map.

Generally, the lighting environment between two adjacent points in space is close, and correspondingly, the lighting environment between two points that are far away is quite different. After mapping these two points into the image, the distance between the two points in space may be represented by the depth between the pixels.

In this embodiment, the spatial continuity loss function may represent the difference in lighting environment between adjacent pixels. When two adjacent pixels have similar depths, it means that they have similar lighting environments, and the value of the spatial continuity loss function is also small. Conversely, when the depth difference between two adjacent pixels is large, it means that the lighting environments of the two may be very different, and the value of the spatial continuity loss function is also large.

In an optional example, step 430 may be executed by the processor calling corresponding instructions stored in the memory, or may be executed by a pre-training unit executed by the processor.

Step 440: training the initial-lighting-feature prediction model based on the value of the prediction loss function and the value of the spatial continuity loss function to acquire a pre-trained lighting feature prediction model.

In an optional example, step 440 may be executed by the processor calling corresponding instructions stored in the memory, or may be executed by a pre-training unit executed by the processor.

In this embodiment, the execution entity may iteratively execute the above steps 410 to 440, and adjust the parameter of the initial-lighting-feature prediction model based on the value of the prediction loss function and the value of the spatial continuity loss function until the prediction loss function and the spatial continuity loss function converge or the number of iterative executions of steps 410 to 440 reaches a preset number, and the training may be terminated to acquire a pre-trained lighting prediction model.

The embodiment shown in FIG. 4 embodies the steps of using the prediction loss function and the spatial continuity loss function to constrain the pre-training of the lighting prediction model. The spatial continuity loss function may provide an overall constraint on the local lighting in the image to be processed to prevent sudden lighting changes, so that constraining the pre-training of the lighting prediction model in this way can improve the accuracy of the lighting prediction model and help to more accurately obtain the lighting features of the image to be processed.

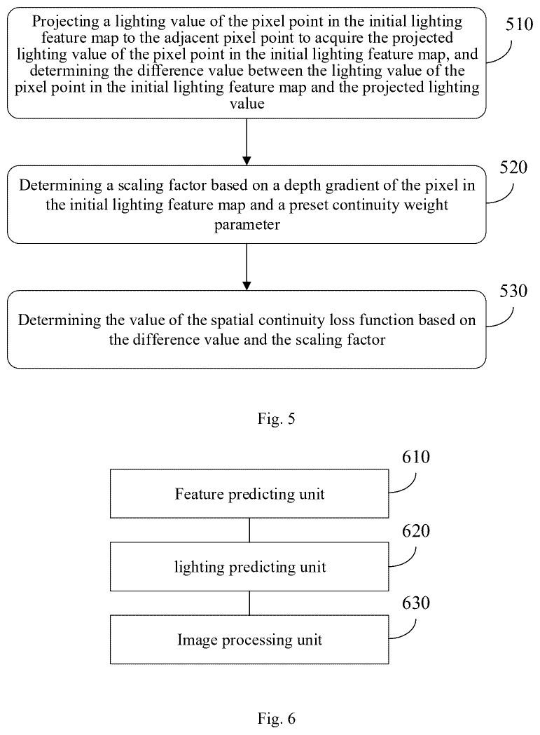

In some optional implementations of the embodiment shown in FIG. 4, the value of the spatial continuity loss function may be determined by the process shown in FIG. 5. As shown in FIG. 5, the process includes the following steps.

Step 510: projecting a lighting value of the pixel point in the initial lighting feature map to the adjacent pixel point to acquire the projected lighting value of the pixel point in the initial lighting feature map, and determining the difference value between the lighting value of the pixel point in the initial lighting feature map and the projected lighting value.

In this embodiment, the difference value between the lighting value of the pixel point in the initial lighting feature map and the projected lighting value may represent the difference in lighting environment between adjacent pixel points.

As an example, the execution entity may realize the projection of the lighting value through the projection operator, and project the lighting value of each pixel point to the adjacent pixel point in a predetermined direction to acquire the projected lighting value of each pixel point, and afterwards, determines the difference between the lighting value of each pixel point and the projected lighting value.

In an optional example, step 510 may be executed by a processor calling corresponding instructions stored in a memory, or may be executed by a pre-training unit executed by the processor.

Step 520: determining a scaling factor based on a depth gradient of the pixel point in the initial lighting feature map and a preset continuity weight parameter. The scaling factor is positively correlated with the depth gradient.

In this embodiment, the pixel depth gradient may represent a distance between points corresponding to adjacent pixels in space. The value of the continuity weight parameter may usually be set based on experience.

For example, the execution entity may first predict the depth gradient of two adjacent pixels, and then determine the scaling factor based on the depth gradient and the continuity weight parameter. The scaling factor may allow for a certain deviation in the lighting environment between at least one pixel.

In an optional example, step 520 may be executed by the processor calling corresponding instructions stored in the memory, or may be executed by a pre-training unit executed by the processor.

Step 530: determining a value of the spatial continuity loss function based on the difference value and the scaling factor.

As an example, the execution entity may multiply the difference corresponding to each pixel by its corresponding scaling factor, and then use the mean of the sum of the products corresponding to all the pixels as the value of the spatial continuous loss function.

As an example, the spatial continuity loss function in this embodiment may adopt the following formula (7):

$${L}_{SC} = \frac{1}{N} \sum \vert Warp ( \tilde{L} ) - \tilde{L} \vert ⊙ {e}^{β {‖ \overline{v} \tilde{d} ‖}_{1}} \qquad ( 7 )$$

where L_{SC} represents the spatial continuity loss function, N represents the number of pixels, Warp( ) represents the projection operator, L represents the predicted lighting value, e^{β∥∇\tilde{d}∥}₁ represents the scaling factor, β represents the continuity weight parameter, and ∇\tilde{d} represents the predicted depth gradient.

In an optional example, step 530 may be executed by the processor calling corresponding instructions stored in the memory, or may be executed by a pre-training unit executed by the processor.

In the process shown in FIG. 5, the difference between the lighting environments of adjacent pixels is represented by the difference between the lighting value of the pixel and the projected lighting, the scaling factor is determined based on the depth gradient of the pixel and the continuity weight parameter, and the value of the spatial continuity loss function is determined by the difference between the lighting value of the pixel and the projected lighting and the scaling factor, which can more accurately represent the difference between the lighting environments of points at different positions in space. For example, the lighting environments of points that are farther away may have larger differences, and the lighting environments of points that are closer may be relatively close. By constraining the pre-training process of the lighting prediction model in this way, the lighting prediction model may learn the potential relationship between the position of a point in space and the lighting environment, thereby improving the prediction accuracy.

In some optional implementations of the above embodiments, after the acquiring the geometric feature map and material feature map of the image to be processed through step 110, the albedo feature map and the roughness feature map may further be processed as follows: inputting the image to be processed, the geometric feature map and the material feature map into a guided filtering model to determine a filtering parameter; and smoothing the albedo feature map and the roughness feature map based on the filtering parameter.

In this embodiment, the guided filtering model may be used to smooth the albedo feature map and the roughness feature map to improve the image quality of the albedo feature map and the roughness feature map. Inputting the smoothed albedo feature map and roughness feature map into the lighting prediction model helps to improve the prediction accuracy of the lighting features; at the same time, when the smoothed albedo feature map and roughness feature map are used to perform preset processing on the image to be processed, the quality of the processed image can be improved.

As an example, the guided filtering model may be a convolutional neural network embedded with a guided filtering layer.

Furthermore, the filtering parameter is acquired in the following manner: generating an input image based on the image to be processed, the geometric feature map and the material feature map, where the resolution of the input image is smaller than the resolution of the image to be processed; and predicting initial filtering parameters of the input image by using the guided filtering model, and up-sampling the initial filtering parameters to acquire a filtering parameter consistent with the resolution of the image to be processed.

As an example, the resolution of the image to be processed, the geometric feature map, and the material feature map may be reduced to half of the original resolution, and then input into the guided filtering model to acquire an initial filtering parameter of half the resolution, and then the initial filtering parameter is up-sampled to acquire a filtering parameter consistent with the original resolution.

In this embodiment, by reducing the resolution of the input image to obtain the initial filtering parameter, and then acquiring a filtering parameter consistent with the input image through up-sampling, the filtering parameters can be obtained more quickly, which helps to improve the efficiency of guiding the filtering model to smooth the image.

Any method for inverse rendering images according to the embodiments of the present disclosure may be executed by any appropriate device with data processing capabilities, including but not limited to: a terminal device and a server. Alternatively, any one of the methods for inverse rendering images according to the embodiments of the present disclosure may be executed by a processor, such as the processor executing the method for inverse rendering images mentioned in the embodiments of the present disclosure by calling corresponding instructions stored in a memory. This will not be elaborated below.

Those skilled in the art may understand that all or part of the steps of implementing the above method embodiment may be completed by hardware related to program instructions, and the aforementioned program may be stored in a computer-readable storage medium. When the program is executed, it executes the steps of the above method embodiment; and the aforementioned storage medium includes: ROM, RAM, magnetic disk or optical disk, etc., various media that can store program codes.

Referring to FIG. 6, FIG. 6 shows a schematic structural diagram of an embodiment of a device for inverse rendering an image according to the present disclosure. The device of this embodiment may be used to implement the above-mentioned various method embodiments of the present disclosure. As shown in FIG. 6, the device includes: a feature predicting unit 610 configured to input an image to be processed into a feature prediction model, predict a geometric feature and a material feature of the image to be processed by the feature prediction model to acquire a geometric feature map and a material feature map of the image to be processed, where the geometric feature map includes a normal map and a depth map, and the material feature map includes an albedo feature map, a roughness feature map, and a metalness feature map; a lighting predicting unit 620 configured to input the image to be processed, the geometric feature map and the material feature map into a lighting prediction model, and predict a lighting value of the image to be processed pixel by pixel by the lighting prediction model to acquire a lighting feature map of the image to be processed; and an image processing unit 630 configured to perform preset processing on the image to be processed based on the geometric feature map, the material feature map and the lighting feature map.

In one embodiment, the lighting predicting unit 620 further includes: a predicting module configured to process the image to be processed, the geometric feature map and the material feature map by using the lighting prediction model, predict the lighting value of the pixel point in the image to be processed, and generate a panoramic image corresponding to the pixel point based on the predicted lighting value; and a splicing module configured to splice the panoramic image corresponding to the pixel point in the image to be processed to acquire a lighting feature map.

In one embodiment, the device further includes a model training unit configured to: input a sample image into a pre-trained feature prediction model, predict the geometric feature and the material feature of the sample image to acquire a sample geometric feature map and a sample material feature map of the sample image; input the sample image, the sample geometric feature map and the sample material feature map into the pre-trained lighting prediction model, predict the lighting value of the pixel point in the sample image to acquire the sample lighting feature map of the sample image; generate a rendered image based on the sample geometric feature map, the sample material feature map, and the sample lighting feature map by using a differentiable rendering module; and adjust parameters of the pre-trained feature prediction model and the pre-trained lighting prediction model based on the difference between the sample image and the rendered image, until the preset training completion conditions are met to acquire the feature prediction model and the lighting prediction model.

In one embodiment, the device further includes a pre-training unit configured to: obtain an initial lighting feature map acquired by processing sample data with an initial-lighting-feature prediction model; determine a value of the prediction loss function based on the difference between the initial lighting feature map and the sample label; determine a value of the spatial continuity loss function based on the difference between the lighting values of adjacent pixels and the difference between the depths of adjacent pixels in the initial lighting feature map; and train the initial-lighting-feature prediction model based on the value of the prediction loss function and the value of the spatial continuity loss function to acquire a pre-trained lighting feature prediction model.

In one embodiment, the pre-training unit further includes a loss function module configured to: project a lighting value of the pixel point in the initial lighting feature map to the adjacent pixel point to acquire the projected lighting value of the pixel point in the initial lighting feature map, and determine the difference value between the lighting value of the pixel point in the initial lighting feature map and the projected lighting value; determine a scaling factor based on a depth gradient of the pixel point in the initial lighting feature map and a preset continuity weight parameter, where the scaling factor is positively correlated with the depth gradient; and determine a value of the spatial continuity loss function based on the difference value and the scaling factor.

In one embodiment, the device further includes a filtering unit configured to: input the image to be processed, the geometric feature map and the material feature map into a guided filtering model, determine a filtering parameter; and smooth the albedo feature map and the roughness feature map based on the filtering parameter.

In one embodiment, the device further includes a parameter determination unit configured to: generate an input image based on the image to be processed, the geometric feature map and the material feature map, where the resolution of the input image is smaller than the resolution of the image to be processed; and predict initial filtering parameters of the input image by using the guided filtering model, and up-sample the initial filtering parameters to acquire a filtering parameter consistent with the resolution of the image to be processed.

In addition, an embodiment of the present disclosure further provides an electronic equipment, which includes:
a memory for storing computer programs; and
a processor for executing the computer programs stored in the memory, and when the computer program is executed, implementing the method for inverse rendering images of any of the above embodiments of the present disclosure.

In addition, an embodiment of the present disclosure further provides a computer-readable storage medium on which computer program instructions are stored. When the computer program instructions are executed by a processor, the method for inverse rendering images of any of the above embodiments may be implemented.

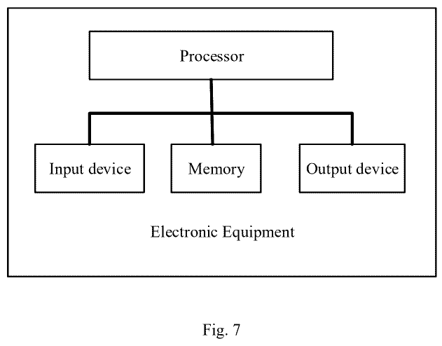

Subsequently, an electronic device according to an embodiment of the present disclosure is described with reference to FIG. 7.

FIG. 7 illustrates a block diagram of an electronic device according to an embodiment of the present disclosure.

As shown in FIG. 7, the electronic device includes one or more processors and a memory.

The processor may be a central processing unit (CPU) or other forms of processing units having data processing capabilities and/or instruction execution capabilities, and may control other components in the electronic device to perform desired functions.

The memory may store one or more computer program products, and the memory may include various forms of computer-readable storage media, such as volatile memory and/or non-volatile memory. The volatile memory may include, for example, a random access memory (RAM) and/or a cache memory (cache). The non-volatile memory may include, for example, a read-only memory (ROM), a hard disk, a flash memory, and the like. One or more computer program products may be stored on the computer-readable storage medium, and the processor may execute the computer program products to implement the methods for inverse rendering images of the various embodiments of the present disclosure described above and/or other desired functions.

In one example, the electronic device may further include: an input device and an output device, and these components are interconnected via a bus system and/or other forms of connection mechanisms (not shown).

In addition, the input device may also include, for example, a keyboard, a mouse, and the like.

The output device may output various information to the outside, including determined distance information, direction information, etc. The output device may include, for example, a display, a speaker, a printer, a communication network and remote output devices connected thereto, and the like.

Of course, for the sake of simplicity, FIG. 7 only shows some of the components in the electronic device that are related to the present disclosure, and omits components such as a bus, an input/output interface, and the like. In addition, the electronic device may further include any other appropriate components according to specific application scenarios.

In addition to the above-mentioned methods and devices, an embodiment of the present disclosure may also be a computer program product, which includes computer program instructions, which, when executed by a processor, enable the processor to execute the steps in the method for inverse rendering images according to various embodiments of the present disclosure described in the above part of this description.

The computer program product may be written in any combination of one or more programming languages to write program codes for executing the operations of the embodiments of the present disclosure, and the programming languages include object-oriented programming languages, such as Java, C++, etc., and further include conventional procedural programming languages, such as “C” language or similar programming languages. The program code may execute entirely on a computing device of user, partly on the computing device of user, as a stand-alone software package, partly on the computing device of user and partly on a remote computing device or entirely on the remote computing device or server.

In addition, an embodiment of the present disclosure may also be a computer-readable storage medium having computer program instructions stored thereon, and when the computer program instructions are executed by a processor, the processor executes the steps of the method for inverse rendering images according to various embodiments of the present disclosure described in the above part of this description.

The computer readable storage medium may take the form of any combination of one or more computer readable media. The readable medium may be a readable signal medium or a readable storage medium. The readable storage medium may include, for example, but is not limited to, electronic, magnetic, optical, electromagnetic, infrared, or semiconductor systems, devices, or components, or any combination of the above. More specific examples of readable storage media (a non-exhaustive list) include: an electrical connection having one or more conductors, a portable disk, a hard disk, a random access memory (RAM), a read-only memory (ROM), an erasable programmable read-only memory (EPROM or flash memory), optical fibers, a portable compact disk-read-only memory (CD-ROM), an optical storage device, a magnetic storage device, or any suitable combination of the foregoing.

The basic principles of the present disclosure are described above in conjunction with specific embodiments. However, it should be pointed out that the advantages, strengths, effects, etc. mentioned in the present disclosure are only examples and not limitations, and it cannot be considered that these advantages, strengths, effects, etc. are necessarily possessed by each embodiment of the present disclosure. In addition, the specific details disclosed above are only for the purpose of illustration and facilitating understanding, and are not limiting. The above details do not limit the present disclosure to being implemented by adopting the above specific details.

Each embodiment in this description is described in a progressive manner, and each embodiment focuses on the differences from other embodiments. The same or similar parts between the embodiments can be referenced to each other. As for the system embodiment, since it basically corresponds to the method embodiment, the description is relatively simple, and the relevant parts can be referred to the partial description of the method embodiment.

The block diagrams of apparatuses, devices, equipment, and systems involved in the present disclosure are merely illustrative examples and are not intended to require or imply that they must be connected, arranged, or configured in the manner shown in the block diagrams. As will be appreciated by those skilled in the art, these apparatuses, devices, equipment, and systems may be connected, arranged, and configured in any manner. Words such as “including”, “comprising”, “having”, etc. are open-ended words meaning “including but not limited to”, and are used interchangeably therewith. As used herein, the terms “or” and “and” mean, and are used interchangeably with, the terms “and/or” unless the context clearly dictates otherwise. As used herein, the word “such as” refers to, and is used interchangeably with, the phrase “such as, but not limited to”.

The methods and devices of the present disclosure may be implemented in many ways. For example, the methods and devices of the present disclosure may be implemented by software, hardware, firmware, or any combination of software, hardware, and firmware. The above sequence for the steps of the method is for illustration only, and the steps of the method of the present disclosure are not limited to the sequence specifically described above unless otherwise specifically stated. Furthermore, in some embodiments, the present disclosure may also be implemented as programs recorded in recording media, and these programs include machine-readable instructions for implementing the methods according to the present disclosure. Thus, the present disclosure also covers a recording medium storing a program for executing the method according to the present disclosure.

It should also be pointed out that in the device, equipment and method of the present disclosure, each component or each step may be decomposed and/or recombined. These decompositions and/or recombination should be regarded as equivalents of the present disclosure.

The above description of the disclosed aspects is provided to enable those skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

The foregoing description has been presented for purposes of illustration and description. Furthermore, the description is not intended to limit the embodiments of the present disclosure to the form disclosed herein. While various example aspects and embodiments have been discussed above, those skilled in the art will recognize certain variations, modifications, permutations, additions, and sub-combinations thereof.

1. A method for inverse rendering an image, characterized by comprising:
inputting an image to be processed into a feature prediction model, predicting a geometric feature and a material feature of the image to be processed by the feature prediction model to acquire a geometric feature map and a material feature map of the image to be processed, wherein the geometric feature map includes a normal map and a depth map, and the material feature map includes an albedo feature map, a roughness feature map, and a metalness feature map;
inputting the image to be processed, the geometric feature map and the material feature map into a lighting prediction model, and predicting a lighting value of the image to be processed pixel by pixel by the lighting prediction model to acquire a lighting feature map of the image to be processed; and
performing preset processing on the image to be processed based on the geometric feature map, the material feature map and the lighting feature map.

2. The method for inverse rendering images of claim 1, wherein the inputting the image to be processed, the geometric feature map and the material feature map into a lighting prediction model, and predicting the lighting value of the image to be processed pixel by pixel by the lighting prediction model to acquire the lighting feature map of the image to be processed includes:
processing the image to be processed, the geometric feature map and the material feature map by using the lighting prediction model, predicting the lighting value of the pixel point in the image to be processed, and generating a panoramic image corresponding to the pixel point based on the predicted lighting value; and
splicing the panoramic images corresponding to the pixel points in the image to be processed to acquire the lighting feature map.

3. The method for inverse rendering images of claim 2, further comprising following steps of obtaining the feature prediction model and the lighting prediction model:
inputting a sample image into a pre-trained feature prediction model, predicting the geometric feature and the material feature of the sample image to acquire a sample geometric feature map and a sample material feature map of the sample image;
inputting the sample image, the sample geometric feature map and the sample material feature map into the pre-trained lighting prediction model, predicting the lighting value of the pixel point in the sample image to acquire the sample lighting feature map of the sample image;
generating a rendered image based on the sample geometric feature map, the sample material feature map, and the sample lighting feature map by using a differentiable rendering module; and
adjusting parameters of the pre-trained feature prediction model and the pre-trained lighting prediction model based on the difference between the sample image and the rendered image, until the preset training completion conditions are met, to acquire the feature prediction model and the lighting prediction model.

4. The method for inverse rendering images of claim 3, further comprising following steps of obtaining the pre-trained lighting prediction model:
obtaining an initial lighting feature map acquired by processing sample data with an initial-lighting prediction model;
determining a value of the prediction loss function based on the difference between the initial lighting feature map and the sample label;
determining a value of the spatial continuity loss function based on the difference between the lighting values of adjacent pixels and the difference between the depths of adjacent pixels in the initial lighting feature map; and
training the initial-lighting prediction model based on the value of the prediction loss function and the value of the spatial continuity loss function to acquire a pre-trained lighting prediction model.

5. The method for inverse rendering images of claim 4, wherein the determining the value of the spatial continuity loss function based on the difference between the lighting values of adjacent pixels and the difference between the depths of adjacent pixels in the initial lighting feature map includes:
projecting a lighting value of the pixel point in the initial lighting feature map to the adjacent pixel point to acquire the projected lighting value of the pixel point in the initial lighting feature map, and determining the difference value between the lighting value of the pixel point in the initial lighting feature map and the projected lighting value;
determining a scaling factor based on a depth gradient of the pixel point in the initial lighting feature map and a preset continuity weight parameter, wherein the scaling factor is positively correlated with the depth gradient; and
determining a value of the spatial continuity loss function based on the difference value and the scaling factor.

6. The method for inverse rendering images of claim 1, wherein after the acquiring the geometric feature map and the material feature map of the image to be processed, the method further comprises:
inputting the image to be processed, the geometric feature map and the material feature map into a guided filtering model to determine a filtering parameter; and
smoothing the albedo feature map and the roughness feature map based on the filtering parameter.

7. The method for inverse rendering images of claim 6, further comprising following steps of obtaining the filtering parameter:
generating an input image based on the image to be processed, the geometric feature map and the material feature map, wherein the resolution of the input image is smaller than the resolution of the image to be processed; and
predicting initial filtering parameters of the input image by using the guided filtering model, and up-sampling the initial filtering parameters to acquire a filtering parameter consistent with the resolution of the image to be processed.

8-14. (canceled)

15. An electronic equipment, characterized by comprising:
a memory configured to store a computer program product; and
a processor configured to execute the computer program product stored in the memory, wherein the computer program product, when executed by the processor, performs the method of claim 1.

16. A computer-readable storage medium, on which computer program instructions are stored, wherein the computer program instructions, when executed by a processor, perform the method of claim 1.

17. The computer-readable storage medium of claim 16, wherein the computer program instructions, when executed by a processor, further perform the method comprising:
inputting an image to be processed into a feature prediction model, predicting a geometric feature and a material feature of the image to be processed by the feature prediction model to acquire a geometric feature map and a material feature map of the image to be processed, wherein the geometric feature map includes a normal map and a depth map, and the material feature map includes an albedo feature map, a roughness feature map, and a metalness feature map;
inputting the image to be processed, the geometric feature map and the material feature map into a lighting prediction model, and predicting a lighting value of the image to be processed pixel by pixel by the lighting prediction model to acquire a lighting feature map of the image to be processed; and
performing preset processing on the image to be processed based on the geometric feature map, the material feature map and the lighting feature map,
wherein the inputting the image to be processed, the geometric feature map and the material feature map into a lighting prediction model, and predicting the lighting value of the image to be processed pixel by pixel by the lighting prediction model to acquire the lighting feature map of the image to be processed includes:
processing the image to be processed, the geometric feature map and the material feature map by using the lighting prediction model, predicting the lighting value of the pixel point in the image to be processed, and generating a panoramic image corresponding to the pixel point based on the predicted lighting value; and
splicing the panoramic images corresponding to the pixel points in the image to be processed to acquire the lighting feature map.

18. The computer-readable storage medium of claim 16, wherein the computer program instructions, when executed by a processor, further perform the method comprising:
inputting an image to be processed into a feature prediction model, predicting a geometric feature and a material feature of the image to be processed by the feature prediction model to acquire a geometric feature map and a material feature map of the image to be processed, wherein the geometric feature map includes a normal map and a depth map, and the material feature map includes an albedo feature map, a roughness feature map, and a metalness feature map;
inputting the image to be processed, the geometric feature map and the material feature map into a lighting prediction model, and predicting a lighting value of the image to be processed pixel by pixel by the lighting prediction model to acquire a lighting feature map of the image to be processed; and
performing preset processing on the image to be processed based on the geometric feature map, the material feature map and the lighting feature map,
wherein the inputting the image to be processed, the geometric feature map and the material feature map into a lighting prediction model, and predicting the lighting value of the image to be processed pixel by pixel by the lighting prediction model to acquire the lighting feature map of the image to be processed includes:
processing the image to be processed, the geometric feature map and the material feature map by using the lighting prediction model, predicting the lighting value of the pixel point in the image to be processed, and generating a panoramic image corresponding to the pixel point based on the predicted lighting value; and
splicing the panoramic images corresponding to the pixel points in the image to be processed to acquire the lighting feature map,
following steps of obtaining the feature prediction model and the lighting prediction model:
inputting a sample image into a pre-trained feature prediction model, predicting the geometric feature and the material feature of the sample image to acquire a sample geometric feature map and a sample material feature map of the sample image;
inputting the sample image, the sample geometric feature map and the sample material feature map into the pre-trained lighting prediction model, predicting the lighting value of the pixel point in the sample image to acquire the sample lighting feature map of the sample image;
generating a rendered image based on the sample geometric feature map, the sample material feature map, and the sample lighting feature map by using a differentiable rendering module; and
adjusting parameters of the pre-trained feature prediction model and the pre-trained lighting prediction model based on the difference between the sample image and the rendered image, until the preset training completion conditions are met, to acquire the feature prediction model and the lighting prediction model.

19. The computer-readable storage medium of claim 16, wherein the computer program instructions, when executed by a processor, further perform the method comprising:
inputting an image to be processed into a feature prediction model, predicting a geometric feature and a material feature of the image to be processed by the feature prediction model to acquire a geometric feature map and a material feature map of the image to be processed, wherein the geometric feature map includes a normal map and a depth map, and the material feature map includes an albedo feature map, a roughness feature map, and a metalness feature map;
inputting the image to be processed, the geometric feature map and the material feature map into a lighting prediction model, and predicting a lighting value of the image to be processed pixel by pixel by the lighting prediction model to acquire a lighting feature map of the image to be processed; and
performing preset processing on the image to be processed based on the geometric feature map, the material feature map and the lighting feature map,
wherein the inputting the image to be processed, the geometric feature map and the material feature map into a lighting prediction model, and predicting the lighting value of the image to be processed pixel by pixel by the lighting prediction model to acquire the lighting feature map of the image to be processed includes:
processing the image to be processed, the geometric feature map and the material feature map by using the lighting prediction model, predicting the lighting value of the pixel point in the image to be processed, and generating a panoramic image corresponding to the pixel point based on the predicted lighting value; and
splicing the panoramic images corresponding to the pixel points in the image to be processed to acquire the lighting feature map,
following steps of obtaining the feature prediction model and the lighting prediction model:
inputting a sample image into a pre-trained feature prediction model, predicting the geometric feature and the material feature of the sample image to acquire a sample geometric feature map and a sample material feature map of the sample image;
inputting the sample image, the sample geometric feature map and the sample material feature map into the pre-trained lighting prediction model, predicting the lighting value of the pixel point in the sample image to acquire the sample lighting feature map of the sample image;
generating a rendered image based on the sample geometric feature map, the sample material feature map, and the sample lighting feature map by using a differentiable rendering module; and
adjusting parameters of the pre-trained feature prediction model and the pre-trained lighting prediction model based on the difference between the sample image and the rendered image, until the preset training completion conditions are met, to acquire the feature prediction model and the lighting prediction model,
following steps of obtaining the pre-trained lighting prediction model:
obtaining an initial lighting feature map acquired by processing sample data with an initial-lighting prediction model;
determining a value of the prediction loss function based on the difference between the initial lighting feature map and the sample label;
determining a value of the spatial continuity loss function based on the difference between the lighting values of adjacent pixels and the difference between the depths of adjacent pixels in the initial lighting feature map; and
training the initial-lighting prediction model based on the value of the prediction loss function and the value of the spatial continuity loss function to acquire a pre-trained lighting prediction model.

20. The method for inverse rendering images of claim 2, wherein after the acquiring the geometric feature map and the material feature map of the image to be processed, the method further comprises:
inputting the image to be processed, the geometric feature map and the material feature map into a guided filtering model to determine a filtering parameter; and
smoothing the albedo feature map and the roughness feature map based on the filtering parameter.

21. The method for inverse rendering images of claim 20, further comprising following steps of obtaining the filtering parameter:
generating an input image based on the image to be processed, the geometric feature map and the material feature map, wherein the resolution of the input image is smaller than the resolution of the image to be processed; and
predicting initial filtering parameters of the input image by using the guided filtering model, and up-sampling the initial filtering parameters to acquire a filtering parameter consistent with the resolution of the image to be processed.

22. The method for inverse rendering images of claim 3, wherein after the acquiring the geometric feature map and the material feature map of the image to be processed, the method further comprises:
inputting the image to be processed, the geometric feature map and the material feature map into a guided filtering model to determine a filtering parameter; and
smoothing the albedo feature map and the roughness feature map based on the filtering parameter.

23. The method for inverse rendering images of claim 22, further comprising following steps of obtaining the filtering parameter:
generating an input image based on the image to be processed, the geometric feature map and the material feature map, wherein the resolution of the input image is smaller than the resolution of the image to be processed; and
predicting initial filtering parameters of the input image by using the guided filtering model, and up-sampling the initial filtering parameters to acquire a filtering parameter consistent with the resolution of the image to be processed.

24. The method for inverse rendering images of claim 4, wherein after the acquiring the geometric feature map and the material feature map of the image to be processed, the method further comprises:
inputting the image to be processed, the geometric feature map and the material feature map into a guided filtering model to determine a filtering parameter; and
smoothing the albedo feature map and the roughness feature map based on the filtering parameter.

25. The method for inverse rendering images of claim 24, further comprising following steps of obtaining the filtering parameter:
generating an input image based on the image to be processed, the geometric feature map and the material feature map, wherein the resolution of the input image is smaller than the resolution of the image to be processed; and
predicting initial filtering parameters of the input image by using the guided filtering model, and up-sampling the initial filtering parameters to acquire a filtering parameter consistent with the resolution of the image to be processed.

26. The method for inverse rendering images of claim 5, wherein after the acquiring the geometric feature map and the material feature map of the image to be processed, the method further comprises:
inputting the image to be processed, the geometric feature map and the material feature map into a guided filtering model to determine a filtering parameter; and
smoothing the albedo feature map and the roughness feature map based on the filtering parameter.

27. The method for inverse rendering images of claim 26, further comprising following steps of obtaining the filtering parameter:
generating an input image based on the image to be processed, the geometric feature map and the material feature map, wherein the resolution of the input image is smaller than the resolution of the image to be processed; and
predicting initial filtering parameters of the input image by using the guided filtering model, and up-sampling the initial filtering parameters to acquire a filtering parameter consistent with the resolution of the image to be processed.
